(19) United States
(12) Patent Application Publication
(10) Pub. No.: US 2006/0026376 A1
(43) Pub. Date: Feb. 2, 2006

(54) Retrieving graphics from slow retrieval storage devices

(75) Inventors: Kevin Leigh LaChapelle, Redmond, WA (US); Brian James Walker, Duvall, WA (US); Ian Cameron Mercer, Sammamish, WA (US); Keisuke Matsuo, Ikoma-city (JP); Harutoshi Miyamoto, Ibaraki-city (JP); Yasuyuki Torii, Yawata-city (JP); Nobuyasu Takeguchi, Kawachinagano-city (JP)

Correspondence Address: SENNIGER POWERS, ONE METROPOLITAN SQUARE, 16TH FLOOR, ST. LOUIS, MO, 63102, US

(73) Assignees: Microsoft Corporation, Redmond, WA (US); Matsushita Electric Industrial Co., Ltd., Kadoma-shi (JP)

(21) Appl. No.: 11/168,089

(22) Filed: Jun. 28, 2005

Related U.S. Application Data
(63) Continuation-in-part of application No. 10/273,411, filed on Oct. 17, 2002.
(60) Provisional application No. 60/418,973, filed on Oct. 16, 2002.

(51) Int. Cl. G06F 12/16; G06F 12/14

(52) U.S. Cl. 711/170; 711/173

(57) ABSTRACT

Storing image data for a menu in a compound image file. Image data for a menu of media files is retrieved and efficiently stored in the compound image file. A media player accesses the compound image file to obtain and display relevant images in a menu. The invention reduces the quantity of file operations needed to render the menu and thus reduces the time needed to display the menu as perceived by a user. As a result, the invention enhances the user experience with the media player.

### CROSS-REFERENCE TO RELATED APPLICATION

This application is a continuation-in-part of co-pending U.S. patent application Ser. No. 10/273,411, filed Oct. 17, 2002, entitled “Adaptive Menu System for Media Players,” hereby incorporated by reference, which claims the benefit of U.S. Provisional Patent Application Ser. No. 60/418,973, filed Oct. 16, 2002, entitled “COMPRESSED MEDIA FORMAT SPECIFICATION,” now abandoned.

### BACKGROUND

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Many computers are also equipped with digital versatile disc (DVD) drives enabling users to watch movies.

In some multimedia environments, a computer has access to a computer-readable medium storing compressed media files such as Moving Picture Experts Group audio layer-3 (MP3) files and WINDOWS MEDIA technologies audio (WMA) files. When the media files are rendered on a computer, the computer typically has access to a database storing metadata describing albums, artists, genres, years, or the like for the media files. The computer typically organizes the media files into playlists based on the metadata when the compressed media files are played on the computer. For example, in the case of audio media files, the files may be organized by album, artist, genre, year, or some user specified selection and ordering. This allows users to easily have access to all of their content regardless of whether or not the users manually created a playlist.

However, low-end rendering devices with limited resources take a long time to display on-screen graphics. These devices are often constrained in disk-seek and processing power. For example, a low end DVD player contains a 16 bit processor having a two second seek time. Some existing devices require extra time to display the on screen images because the on screen menu images are each stored as a separate file on the media. Each image file is located on the disk, opened, and then decoded for display. For example, if a menu lists seven items of content, the device has to open eight image files: the background image file plus seven thumbnail image files for the content items. Existing devices have to open many files to display a menu and these devices may experience delays in seeking each of the files.

Accordingly, a system including an efficient storage model for menu images is desired to address one or more of these and other disadvantages.

### SUMMARY

Embodiments of the invention accelerate the loading and display of a menu of media files on consumer electronic devices having a low-power processor, limited memory and/or limited display capabilities. In an embodiment, the invention stores relevant image data for the menu in an optimized image data store such as a compound image file. The compound image file includes the relevant image data organized in a memory efficient manner. For example, the boundaries of each compound image file correspond to the sector size of the computer-readable medium storing the compound image file. In one embodiment, a device need only run a single seek-and-open operation to load a menu. Once the compound image file has been opened, the menu images may be read in a single operation provided there is sufficient buffer memory available. By reducing the number of file operations, the load and display times of a device are greatly improved.

Alternatively, aspects of the invention may comprise various other methods and apparatuses.

Other features will be in part apparent and in part pointed out hereinafter.

### BRIEF DESCRIPTION OF THE DRAWINGS

FIG. 1 is a block diagram illustrating an exemplary media environment in which the invention may be implemented.

FIG. 2 is an exemplary block diagram illustrating a relationship between menus and compound image files.

FIG. 3 is an exemplary flow chart illustrating operation of logic to create a compound image file.

FIG. 4 is an exemplary flow chart illustrating operation of logic to render a menu using a compound image file.

FIG. 5 is an exemplary block diagram illustrating a structure of a compound image file.

FIG. 6 is an exemplary block diagram illustrating a structure of a menu file.

FIG. 7A and FIG. 7B are exemplary flow charts illustrating the creation of a compound image file.

FIG. 8A and FIG. 8B are exemplary flow charts illustrating the display of a menu using a compound image file.

FIG. 9 is a screenshot of an exemplary menu displaying thumbnail images corresponding to media content in the menu.

FIG. 10 is a block diagram illustrating one example of a suitable computing system environment in which aspects of the invention may be implemented.

Corresponding reference characters indicate corresponding parts throughout the drawings.

### DETAILED DESCRIPTION

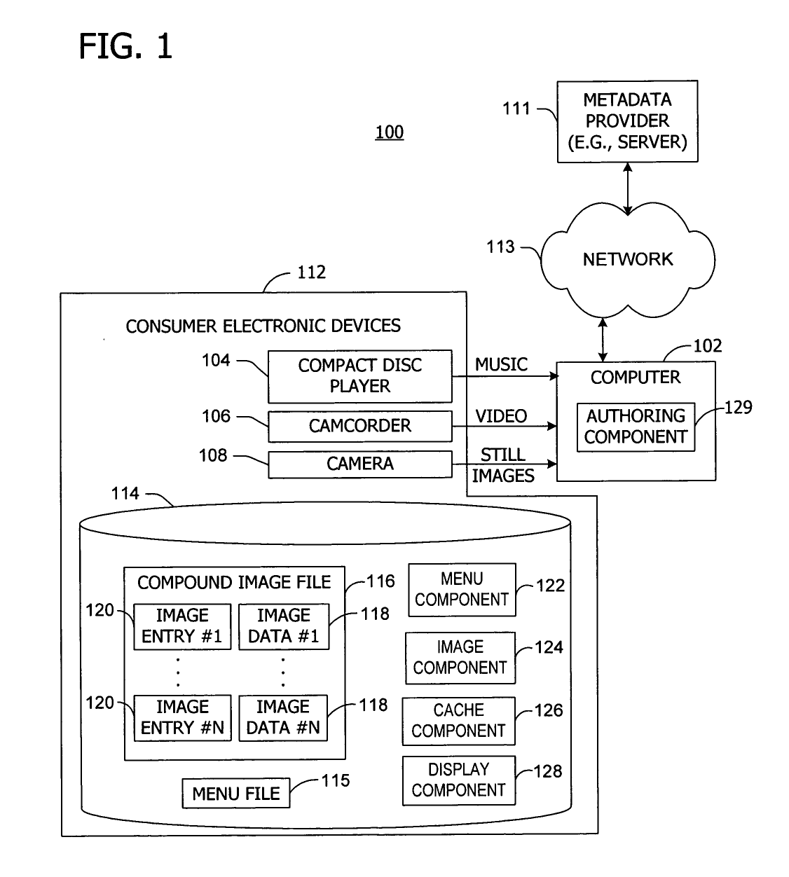

Referring first to FIG. 1, a block diagram illustrates an exemplary media environment in which the invention may be implemented. A system 100 has one or more computers 102 coupled to one or more consumer electronic devices 112 providing media content including audio data, video data, and/or still image data. For example, the devices 112 may include a compact disc (CD) player 104, a camcorder 106, or a camera 108. Additionally, the devices 112 may include other personal computers, removable hard drives, network shares, a Moving Picture Experts Group audio layer-3 (MP3) player, an audio system in an automobile, a personal digital assistant, a cellular telephone, or the like. The consumer electronic devices 112 may include any suitable rendering filter or media player or device (e.g., a portable media device) that is configured to render digital media so that the user can experience the content that is embodied on the consumer electronic device 112. For example, suitable media player applications include a compact disc (CD) media player and a digital versatile disc or digital video disc (DVD) media player. The computer 102 also has rendering capability including a processor and rendering software (e.g., a media player).

One aspect of the present invention enables the user or, particularly, enables a media player program executing on computing device 112, to access, retrieve, and display for the user, so-called metadata. Those skilled in the art are familiar with metadata, which is simply information about data. In the context of the illustrated embodiment, metadata includes information related to specific content of a digital media file being played on the media player. Basic metadata includes, but is not limited to, title, performer, genre, track number, and the like. Extended metadata includes, but is not limited to, cover art, composer, description of content, performer biographies, reviews, ratings, related performers, where to buy similar items, upcoming concerts, ticket sales, URLs to other related experiences including purchase opportunities, studio, director, and the like. In one embodiment, extended metadata may be organized into two main categories: metadata retrieved or downloaded, and metadata computed from the media file (e.g., digital signal processing of the file stream). The metadata may be stored within the media file or stored in another file accessible and known to the media file.

In one example, additional metadata is available from the metadata provider 111 via a data communication network 113. The computer 102 and metadata provider 111 are coupled to the data communication network 113. While the network 113 includes the Internet in one example, the teachings of the invention may be applied to any data communication network. Data communication network 113 may support, for example, client/server communications or peer-to-peer connections.

The consumer electronic devices 112 or computer 102 may have access to one or more computer-readable media (e.g., memory area 114). While the memory area 114 is illustrated to be part of any of the consumer electronic devices 112 in FIG. 1, the memory area 114 may be separate from the consumer electronic devices 112 yet accessible to the consumer electronic devices 112, for example, via a network.

In one embodiment, memory area 114 stores a compound image file 116. The compound image file 116 includes the relevant image data 118 for a menu. The menu may be defined in a menu file 115, a menu structure file, or the like. The relevant image data 118 may include all images associated with the menu such as a background image and one thumbnail image for each media file or other item of content listed in the menu. In general, the compound image file 116 may store a plurality of image data 118 such as image data #1 through image data #N. Each of the image data 118 corresponds to an image that is associated with a media file. The media file is associated with at least one menu. The compound image file 116 also includes a plurality of image entries 120 such as image entry #1 through image entry #N each storing a reference (not shown) to one of the plurality of images. Each of the plurality of image entries 120 further stores a menu identifier (not shown) identifying the menu associated with the image entry 120. In one embodiment, the compound image file 116 further stores a menu entry (not shown) associated with each menu that identifies a background color and/or a text color for the menu.

In one embodiment, the consumer electronic devices 112 (e.g., a portable media device) are configured to execute computer-executable instructions for presenting a menu of media content to a user. The computer-executable instructions may be organized into one or more components. For example, the consumer electronic devices 112 may store a menu component 122, an image component 124, a cache component 126, and a display component 128. The menu component 122 receives menu data from memory area 114. The menu data defines a menu of media files. Each of the media files has an image associated therewith. The image component 124 identifies, from the menu data received by the menu component 122, the compound image file 116 associated with the menu data. The compound image file 116 stores image data 118 (e.g., a thumbnail image) for each of the media files. The cache component 126 retrieves the image data 118 from the identified compound image file 116 as a function of the menu data. The display component 128 renders, to a user for navigation and selection, the menu with the image data 118 retrieved by the cache component 126. In one embodiment, the menu data is stored within the compound image file 116.

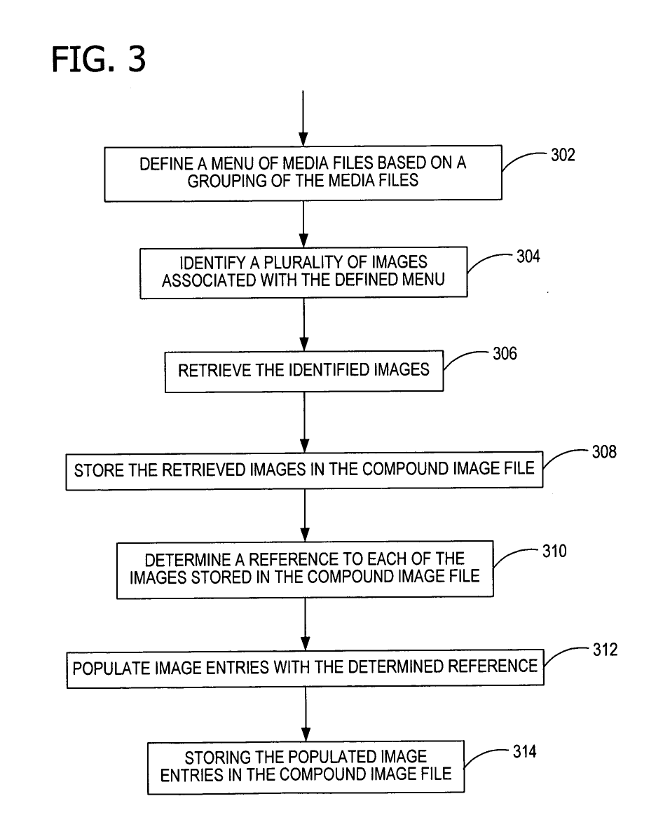

The computer 102, or other device or software, also has one or more exemplary modules or components for implementing aspects of the invention. In one embodiment, the computer 102 or other device with menu rendering capability has access to and may execute the menu component 122, the image component 124, the cache component 126, and the display component 128 to present a menu of media content to a user. In another embodiment, the computer 102 or other rendering device with authoring capability may have a computer-executable component such as an authoring component 129 for defining the menu data based on a grouping of the media files, identifying the image data 118 for the media files, receiving the identified image data 118 from a metadata provider or the like (e.g., from a metadata repository, from within the image files), and storing the retrieved image data 118 in the compound image file 114. These operations are described in FIG. 3.

The invention software may be implemented with any number and organization of components or modules. That is, the invention is not limited to the specific configuration of the menu component 122, image component 124, cache component 126, display component 128, the authoring component 129, or any other computer-executable instructions executed by the consumer electronic devices 112 and/or computer 102, but may include more or less components having more or less individual functionality than described herein. Further, the invention may be embodied in hardware, software, or a combination thereof in a media player, operating system, DVD recorder, CD recorder, video camera, hard drive, flash drive, personal digital assistant, wireless device (e.g., cellular telephone), or the like.

The invention allows a device to do a single seek and open operation to display most menus. Once open, the menu images may be read in a single operation given enough buffer memory in the device. A single seek operation may take up to two seconds. The invention reduces the number of file operations needed to display a menu. Further, images are stored in the compound image files 116 on boundaries corresponding to a sector size of the computer-readable medium storing the compound image file 116. This improves the seek efficiency as all seeks in the file are guaranteed to occur on a sector boundary. As such, the invention greatly improves the load and display times for the menu to enhance the consumer experience.

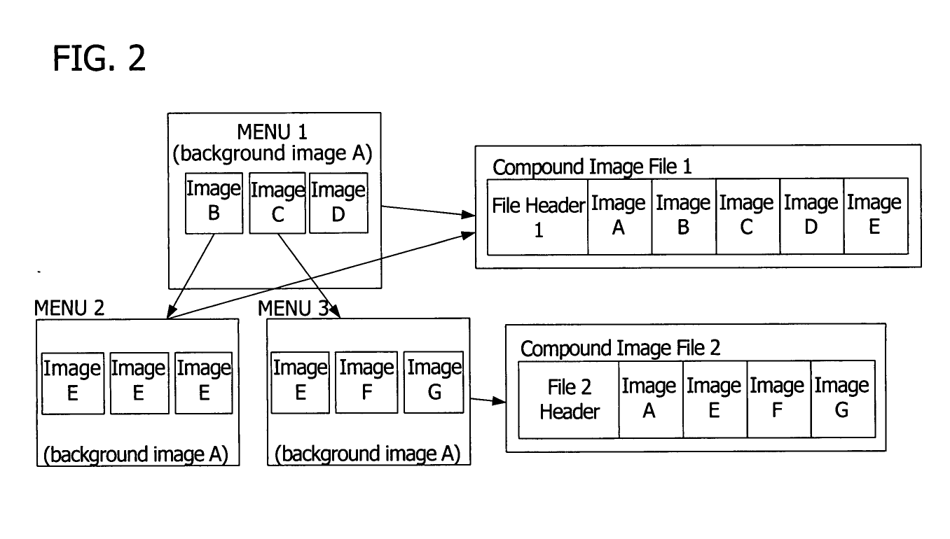

Referring next to FIG. 2, an exemplary block diagram illustrates a relationship between menus and compound image files. Menu 1, Menu 2, and Menu 3 share a common background Image A. Images B-G are thumbnail images for the menus. Each of the thumbnail images shown in the menus of FIG. 2 corresponds to a menu item in the menus. Menu 1 includes background Image A and has Image B, Image C, and Image D as the thumbnail images for the menu items. Menu 2 includes background Image A and has Image E as the thumbnail image for each of three menu items. Menu 3 includes background Image A and has Image E, Image F, and Image G as the thumbnail images for the menu items.

In the example of FIG. 2, the images for Menu 1, Menu 2, and Menu 3 are stored in two compound image files (e.g., Compound Image File 1 and Compound Image File 2). However, a rendering device only needs to open one compound image file to render any of Menu 1, Menu 2, or Menu 3. In another example (not shown), all the images for the entire menu tree of FIG. 2 (e.g., Menu 1, Menu 2, and Menu 3) are contained within a single compound image file.

Referring next to FIG. 3, an exemplary flow chart illustrating operation of logic to create a compound image file in one embodiment. The method in FIG. 3 defines a menu of media files based on a grouping of the media files at 302. For example, the grouping of the media files may be determined from user input (e.g., a user playlist) or from characteristics of the media files (e.g., songs by artist, songs by album). The defined menu of media files may be stored in a menu structure file. The method in the embodiment of FIG. 3 further identifies a plurality of images associated with the defined menu at 304 and retrieves the identified plurality of images from a metadata repository, metadata provider, or the like at 306. In one example, the identified plurality of images is retrieved from the corresponding media files. The method stores the retrieved plurality of images in the compound image file at 308 and determines a reference to each of the plurality of images stored in the compound image file at 310. In another embodiment, the method determines the references prior to storing the images in the compound image files based on the size of each image and the sector boundary of the computer-readable medium on which the compound image file is stored.

The method further populates each of a plurality of image entries with the determined references at 312. The image entries act as an index table. The method associated each image entry with a particular menu by populating each image entry with a menu identifier associated with the particular menu. The populated image entries are stored in the compound image file on the computer-readable medium at 314.

In one embodiment, one or more computer-readable media have computer-executable instructions for performing the computerized method illustrated in FIG. 3.

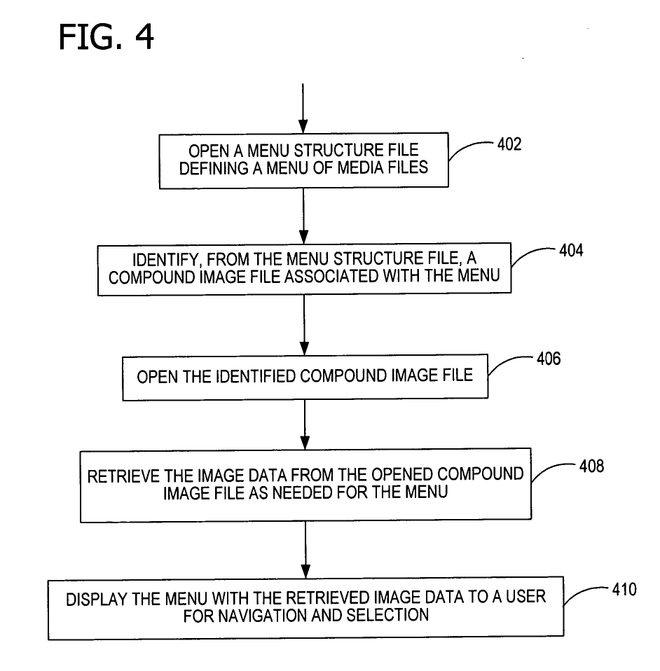

Referring next to FIG. 4, an exemplary flow chart illustrates operation of logic to render a menu using a compound image file in one embodiment. The method illustrated in FIG. 4 generally operates in response to a request from a user or application program to display a menu. The method opens a menu structure file that defines a menu of media files at 402. The method includes identifying, from the opened menu structure file, a compound image file associated with the menu at 404 and opening the identified compound image file at 406. The compound image file stores image data (e.g., thumbnail images) for each of the media files in the menu. The method in this embodiment retrieves the image data from the opened compound image file as a function of the menu at 408. For example, the method retrieves the image data from the opened compound image file in portions corresponding to a sector size of a memory area storing the compound image file. The method displays the menu with the retrieved image data to a user for navigation and selection at 410.

The exemplary method illustrated in FIG. 4 may be performed by any rendering logic such as a media player embodied in any form (e.g., a device, a software product, firmware). In one embodiment, one or more computer-readable media have computer-executable instructions for performing the computerized method illustrated in FIG. 4.

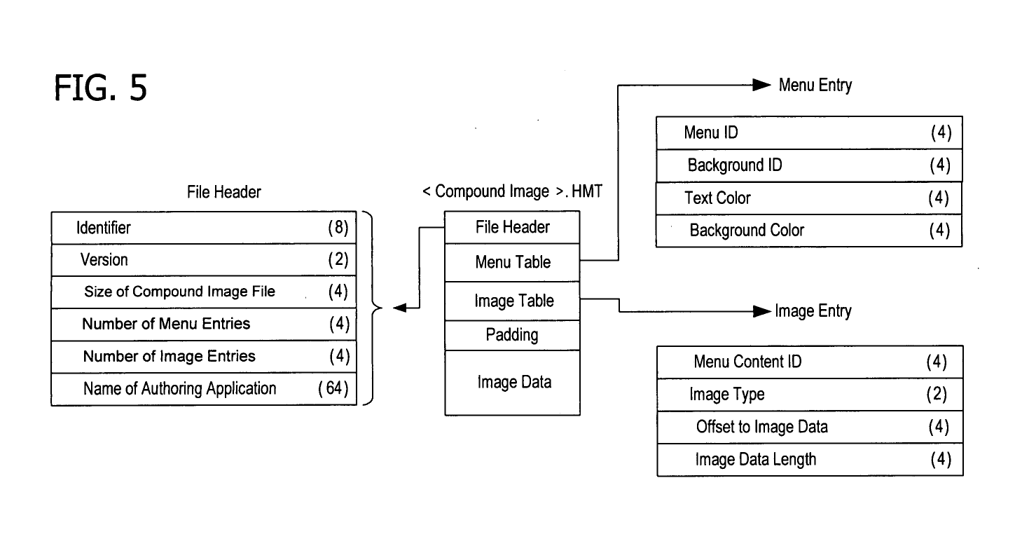

Referring next to FIG. 5, an exemplary block diagram illustrates a structure of a compound image file. While some of the examples herein discuss thumbnail images as the image data for each of the media files in a menu, the invention is not limited to thumbnail images. The invention is operable with any graphical data associated with the menu.

The compound image file includes an index table identifying each thumbnail stored within the compound image file. The compound image file may contain images for multiple menus, but a menu will never span multiple compound image files. Thumbnails are duplicated across compound image files as necessary. FIG. 5 illustrates a structure of an exemplary compound image file <Compound Image>.HMT. Each compound image file is represented as a unique <Compound Image>.HMT file such as nnnnnnnn.HMT file, where nnnnnnnn is an upper-case, string representation of a hexadecimal number without leading zeros. The hexadecimal number is an identifier representing an identifier associated with the compound image file. The fields in an exemplary compound image file header data structure are shown in the table below.

TABLE 1
Compound Image File Header.

| Offset | Length | Field Name |
|---|---|---|
| 0 | 8 | Identifier |
| 8 | 2 | Version |
| 10 | 4 | Size of Compound Image File |
| 14 | 4 | Number of Menu Entries |
| 18 | 4 | Number of Image Entries |
| 22 | 64 | Name of Authoring Application |

The identifier field is an 8-byte entry such as the text string “CMPIFHMT”. The version field is a 2-byte entry representing the version of the specification of this playlist file. The ‘size of compound image file’ field is a 4-byte entry representing the size of the current <Compound Image>.HMT file in bytes. The ‘number of menu entries’ field is a 4-byte entry representing the number of menu entries in the menu table. The ‘number of image entries’ field is a 4-byte entry representing the number of image entries in the compound image file. The ‘name of authoring application’ field is a 64-byte entry representing the text string name of the authoring application.

The menu table includes a list of menu entries sorted in ascending order by the menu identifier. The fields in an exemplary menu entry data structure are shown in the table below.

TABLE 2
Menu Entry.

| Offset | Length | Field Name |
|---|---|---|
| 0 | 4 | Menu ID |
| 4 | 4 | Background ID |
| 8 | 4 | Text Color |
| 12 | 4 | Background Color |

The ‘menu ID’ field is a 4-byte entry representing the menu identifier of the menu header which references the current menu entry. The ‘background ID’ is a 4-byte entry representing the menu content identifier (e.g., Menu Content ID) for the image to display as the background of this menu. A value of zero indicates there is no background image. If this field contains a non-zero value then image data with image type ‘BACKGROUND IMAGE 4×3’ or ‘BACKGROUND IMAGE 16×9’ for the corresponding menu content identifier is stored in the image entry in the current compound image file. The ‘text color’ field is a 4-byte entry defining the color for the text on the current menu on the display. The entry is formatted as an RGB value with 0xFFRRGGBB as the byte order, where 0xFF are the actual hex digits and RR, GG, and BB denote the values of the red, green, and blue values respectively. If the ‘background ID’ field or the ‘background color’ field is populated, then the ‘text color’ field includes a non-zero value. A value of zero means that the player should select a text color that contrasts with the default background color. If a player is not capable of color rendering, this field may be ignored. The ‘background color’ field is a 4-byte entry defining the background color that should be used when the current menu is rendered on the display. It is formatted as an RGB value with 0xFFRRGGBB as the byte order, where 0xFF are the actual hex digits and RR, GG, and BB denote the values of the red, green, and blue values respectively. If the ‘background image ID’ field is defined, the background color is only visible on areas of the display not covered by the background image. A value of zero indicates there is no background color and that the player may use its own default background color. If a player is not capable of color rendering then this field may be ignored.

Image entries are sorted in ascending order by Menu Content ID then Type. There may be multiple entries with the same Menu Content ID provided each has a different Type. Applications or devices with authoring capability add new image data at the end of the entries. When updating the entries, the authoring applications may move the image data “down” a sector (e.g., two kilobytes for a DVD) to make room for another entry. If there are more than 400 images in the compound image file, a new file is created in one embodiment. Any unused space in the image data should be padded with zeros.

In one embodiment, multiple entries point to the same image data. In other embodiments, there is a one-to-one relationship between entries and image data. Further, there is only one entry per Image Type per Menu Content ID in the compound image file. Menus that wish to use the same thumbnails for menu items may use the same Menu Content ID for each of the menu items to minimize the space used in the compound image file. The fields in an exemplary image entry data structure are shown in the table below.

TABLE 3
Image Entry.

| Offset | Length | Field Name |
|---|---|---|
| 0 | 4 | Menu Content ID |
| 4 | 2 | Image Type |
| 6 | 4 | Offset to Image Data |
| 10 | 4 | Image Data Length |

The ‘menu content ID’ field is a 4-byte entry defining the menu content identifier for the corresponding image data that is referenced by menu and playlist items. The menu content identifier is unique within all compound image files on a particular computer-readable medium. The ‘image type’ field is a 2-byte entry representing the image type (e.g., the type of menu image). Exemplary image type values are shown in the table below.

TABLE 4
Image Type.

| Type of Entry | Value |
|---|---|
| 0 | BACKGROUND IMAGE 4 × 3 |
| 1 | BACKGROUND IMAGE 16 × 9 |
| 2 | THUMBNAIL IMAGE |
| 3 | SELECTED THUMBNAIL |
| | IMAGE |
| 4-65,535 | RESERVED |

The ‘offset to image data’ field is a 4-byte entry represents the byte offset from the beginning of the compound image file to the image data for this menu image. This offset value is a multiple of the sector size of the computer-readable medium storing the compound image file (e.g., 2,048 for a DVD). The ‘image data length’ field is a 4-byte entry representing the length in bytes of the image data.

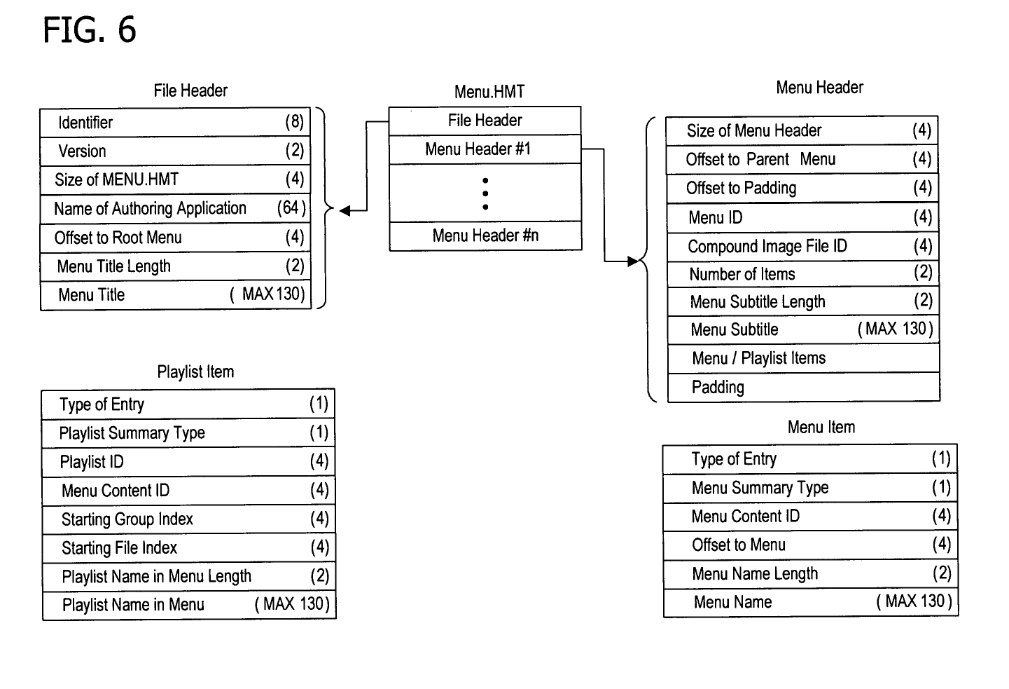

Referring next to FIG. 6, an exemplary block diagram illustrates a structure of a menu file. FIG. 6 illustrates the structure of an exemplary menu file (e.g., MENU.HMT). The fields in an exemplary menu file header data structure are shown in the table below.

TABLE 5
Menu File Header.

| Offset | Length | Field Name |
|---|---|---|
| 0 | 8 | Identifier |
| 8 | 2 | Version |
| 10 | 4 | Size of MENU.HMT |
| 14 | 64 | Name of Authoring Application |
| 78 | 4 | Offset to Root Menu |
| 82 | 2 | Menu Title Length |
| 84 | Variable | Menu Title |

The identifier field is an 8-byte entry such as the text string “MENU_HMT”. The version field is a 2-byte entry representing the version of a specification to which the current menu file conforms. The ‘size of MENU.HMT’ field is a 4-byte entry representing the size of the current MENU.HMT file in bytes. The ‘name of authoring application’ field is a 64-byte entry representing the text string name of the authoring application. The ‘offset to root menu’ field is a 4-byte entry representing the byte offset from the beginning of the current MENU.HMT to the root menu header. The ‘menu title length’ field is a 2-byte entry representing the byte length of the menu title (excluding any termination null bytes). The ‘menu title’ field is the menu title as a text string. An empty string (e.g., one null character) indicates that there is no title to display.

Each menu header represents one menu within the menu hierarchy and contains references to its single parent menu and its child items. Each child item is either a reference to a child menu or a reference to a playlist file. The child menu also has the same format as the menu header. Each child menu is referenced by a single parent menu to form a hierarchical menu structure. The first menu header in MENU.HMT is the top-level menu. In one embodiment, menus support either a background image, a solid background color, or default player behavior. If a background image or background color is defined, the text color is also defined. If a valid text color and background image or color are not defined, the player uses default behavior. Padding is written after each menu header to allow for easier additions to the menu. The amount of padding should not exceed the sector size of the computer-readable medium storing the menu header (e.g., 2,048 bytes for a DVD). Further, the padding may be an even number to preserve 2-byte alignment. The fields in an exemplary menu header data structure are shown in the table below, where ‘n’ represents the number of menu items.

TABLE 6
Menu Header.

| Offset | Length | Field Name |
|---|---|---|
| 0 | 4 | Size of Menu Header |
| 4 | 4 | Offset to Parent Menu |
| 8 | 4 | Offset to Padding |
| 12 | 4 | Menu ID |
| 16 | 4 | Compound Image File ID |
| 20 | 2 | Number of Items |
| 22 | 2 | Menu Subtitle Length |
| 24 | Variable | Menu Subtitle |
| | Variable | Menu or Playlist Item #1 |
| | | . |
| | | . |
| | | . |
| | Variable | Menu or Playlist Item #n |
| | Variable | Padding |

The ‘size of menu header’ field is a 4-byte entry representing the size of the menu header including the menu and playlist items and any padding in bytes. The ‘offset to parent menu’ field is a 4-byte entry representing the byte offset from the beginning of MENU.HMT to the beginning of the menu header corresponding to the parent menu. This value is zero if the current menu header is the top-level menu. The ‘offset to padding’ field is a 4-byte entry representing the byte offset from the beginning of MENU.HMT to the beginning of the padding at the end of the current menu header. This value is zero if there is no padding. The ‘menu ID’ is a 4-byte entry representing the unique identifier for the current menu header in MENU.HMT. In one embodiment, the menu identifiers start at a value of one when the MENU.HMT file is initially created. It is possible for the MENU.HMT file to not have a menu identifier of one after edit operations. The ‘compound image file ID’ field is a 4-byte entry representing the identifier of the compound image file that contains the menu images for the current menu header. The ‘number of items’ field is a 2-byte entry defining the number of menu or playlist items in the current menu. The ‘menu subtitle length’ field is a 2-byte entry representing the byte length of the menu subtitle excluding any ending null bytes. The ‘menu subtitle’ field represents the text string menu subtitle. An empty string (e.g., one null character) indicates that there is no subtitle to display. The ‘menu or playlist item’ field is a variable-sized entry representing either a menu item or a playlist item.

The fields in an exemplary menu item data structure are shown in the table below.

TABLE 7
Menu Item.

| Offset | Length | Field Name |
|---|---|---|
| 0 | 1 | Type of Entry |
| 1 | 1 | Menu Summary Type |
| 2 | 4 | Menu Content ID |
| 6 | 4 | Offset to Menu |
| 10 | 2 | Menu Name Length |
| 12 | Variable | Menu Name |

The ‘type of entry’ field is a 1-byte entry identifying either a menu item or a playlist item. The values of exemplary entry types are shown in the table below.

TABLE 8
Type of Entry.

| Type of Entry | Value |
|---|---|
| 0 | UNUSED |
| 1 | MENU |
| 2 | PLAYLIST |
| 3-255 | RESERVED |

The ‘menu summary type’ field is a value defining the type of playlists that are accessible through the current menu item. This value is a logical OR of the summary types of the items the current menu item contains. The ‘menu content ID’ field is a 4-byte entry representing the menu content identifier of the image file (e.g., a thumbnail image file) for the current menu item in the corresponding compound image file. If there is no image for the current menu item, the value is zero. If this field contains a non-zero value, the image data with an image type of ‘THUMBNAIL IMAGE’ or ‘SELECTED THUMBNAIL IMAGE’ for the current menu content identifier is stored in the image entry in the corresponding compound image file. The ‘offset to menu’ field is a 4-byte entry defining the byte offset from the beginning of MENU.HMT to the sub-menu below this menu item in the menu hierarchy. The ‘menu name length’ field is a 2-byte entry containing the byte length of the name of the menu item (e.g., excluding any ending null bytes). The ‘menu name’ field is a text string name of the menu item as it appears in the menu displayed to the user.

The fields in an exemplary playlist item data structure are shown in the table below.

TABLE 9
Playlist Item.

| Offset | Length | Field Name |
|---|---|---|
| 0 | 1 | Type of Entry |
| 1 | 1 | Playlist Summary Type |
| 2 | 4 | Playlist ID |
| 6 | 4 | Menu Content ID |
| 10 | 4 | Starting Group Index |
| 14 | 4 | Starting File Index |
| 18 | 2 | Playlist Name in Menu Length |
| 20 | Variable | Playlist Name in Menu |

The ‘type of entry’ field is a 1-byte entry defining either a menu item or a playlist item. This value is the value of PLAYLIST from Table 8 above. The ‘playlist summary type’ field is a value defining the type of playlist that this playlist item references. The ‘playlist ID’ field is a 4-byte entry defining the playlist identifier for the current playlist item. The ‘menu content ID’ field is a 4-byte entry representing the menu content identifier of the image file (e.g., a thumbnail image file) for the current playlist item in the corresponding compound image file. If there is no image for this playlist item, the value is zero. If this field contains a non-zero value, the image data with an image type of ‘THUMBNAIL IMAGE’ or ‘SELECTED THUMBNAIL IMAGE’ for the current menu content identifier is stored in the image entry in the corresponding compound image file. The ‘starting group index’ field is a 4-byte entry containing the index of the offset group entry in the offset group table. Playback starts at the playlist group corresponding to the index of the offset group entry contained in this field. A value of one indicates the first playlist group listed in the offset group table in the playlist. The ‘starting file index’ field is a 4-byte entry defining the index of the file in the playlist group at which playback starts. A value of one indicates the first file in the playlist group. The ‘starting group index’ field and the ‘starting file index’ field together allow one playlist to be referenced multiple times in the menu. For example, a menu may show thumbnails for every image on the disk to a user, and each thumbnail returns the user to a different starting point beginning with the selected image. However, the rendering of the playlist ends when the end of the playlist is reached. The ‘playlist name in menu length’ field is a 2-byte entry containing the byte length of the playlist name in the menu (e.g., excluding any null characters). The ‘playlist name in menu’ field is the text string name of the playlist as it appears in the menu displayed to the user.

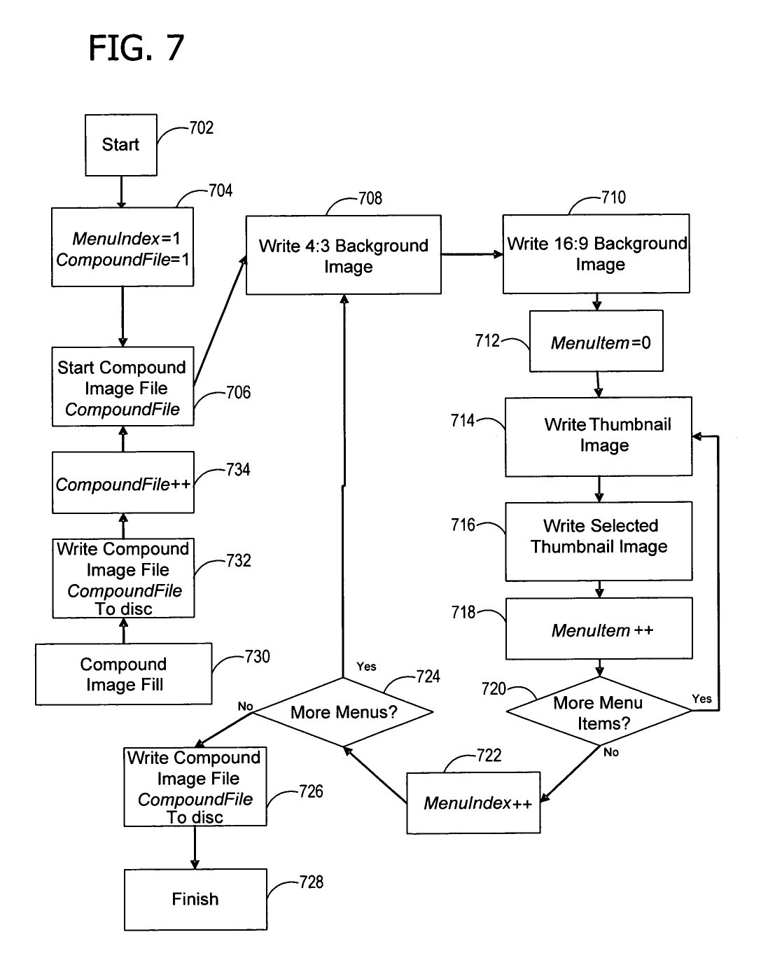

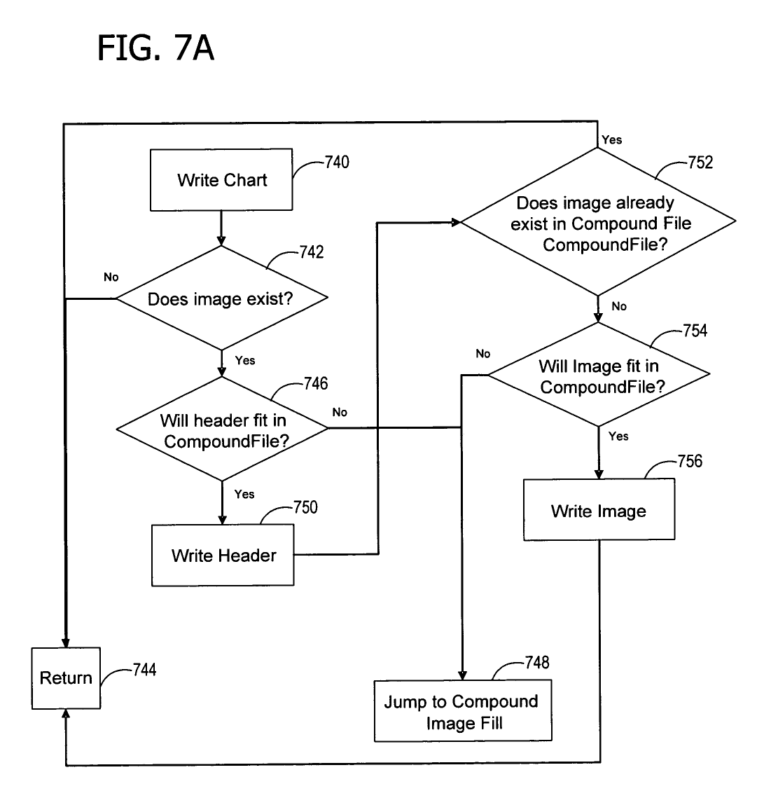

Referring next to FIG. 7, an exemplary flow chart illustrates creation of a compound image file. The process shown in FIG. 7 begins at 702 by setting the variables MenuIndex and CompoundFile to one. The process opens the compound image file CompoundFile at 706 and writes a background image with a 4:3 ratio at 708 and a background image with a 16:9 ratio at 710. The process sets a variable MenuItem to zero at 712 and writes a thumbnail image to the compound image file at 714 and writes a selected thumbnail image to the compound image file at 716. The variable MenuItem is incremented at 718. If there are more menu items at 720, the process returns to write additional thumbnail images at 714. If there are no more menu items at 720, the process increments the MenuIndex variable at 722. If there are more menus to process at 724, the process returns to write the background images at 708 and 710 and perform additional operations. If there are no more menus to write to the compound image file at 724, the compound image file is written to the disc or other computer-readable medium at 726 and the process is finished at 728. If there is a need to pad the compound image file prior to writing the compound image file to the disc, the process fills the compound image at 730, writes the filled compound image file to the disc at 732, increments the variable CompoundFile at 734, and proceeds to open another compound image file at 706 for writing.

Referring next to FIG. 7A, an exemplary flow chart illustrates writing a background image or a thumbnail image to a compound image file. The write chart process begins at 740 in response to a request from another program or routine. If the image to be written does not exist at 742, the process returns at 744 to the requesting program or routine. If the image to be written exists at 742 but the header does not fit into the compound image file at 746, the process returns at 744 to the requesting program. If the header fits in the file at 746, the process writes the header to the file at 750. If the image already exists in the compound image file at 752, the process returns at 744 to the requesting program. If the image does not exist in the compound image file at 752 and the image will fit at 754, the process writes the image to the file at 756 and returns at 744 to the requesting program. If the image will not fit in the compound image file at 754, the process fills the remainder of the compound image file at 748 (e.g., operations 730 et seq. in FIG. 7).

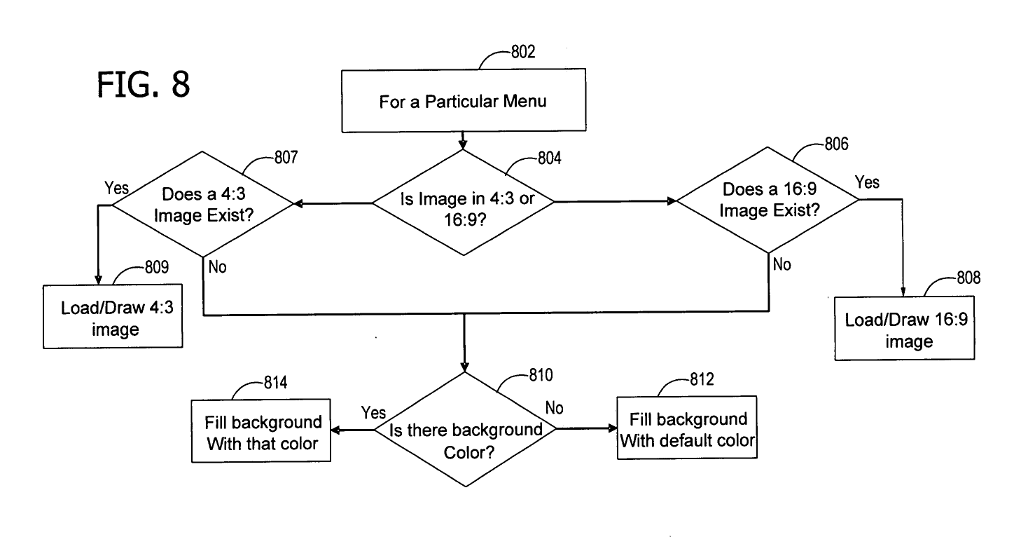

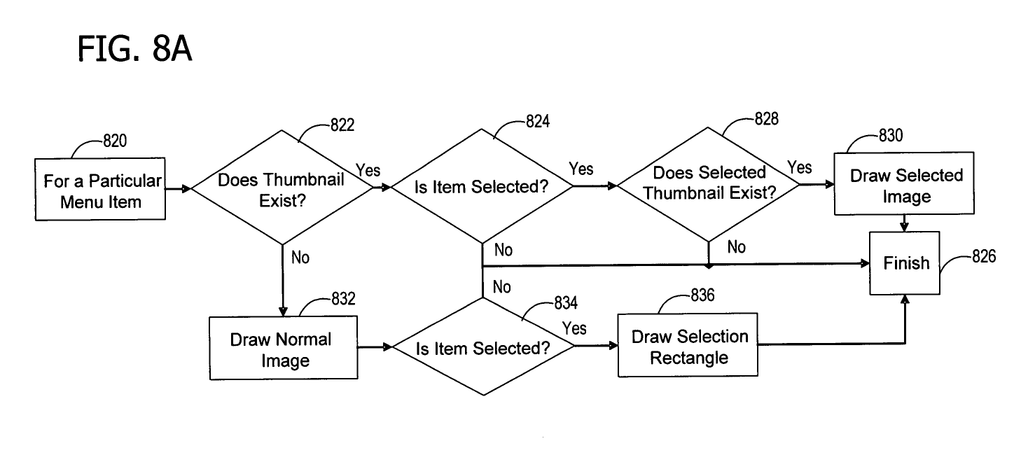

Referring next to FIG. 8, an exemplary flow chart illustrates the display of a background in a menu using a compound image file. For a particular menu at 802, the process determines if the menu has a 4:3 aspect ratio or a 16:9 aspect ratio at 804. If the menu has a 4:3 aspect ratio and the 4:3 aspect ratio image exists at 807, the 4:3 aspect ratio image is loaded or drawn at 809. If the menu has a 16:9 aspect ratio and the 16:9 aspect ratio image exists at 806, the 16:9 aspect ratio image is loaded or drawn at 808. If either the 4:3 aspect ratio image or the 16:9 aspect ratio image does not exist at 807 and 806, respectively, the process determines if there is a background color at 810. If the background color exists, the process fills the background with that color at 814. If the background color does not exist, the process fills the background with a default color at 812.

Referring next to FIG. 8A, an exemplary flow chart illustrates the display of a thumbnail in a menu using a compound image file. For a particular menu item at 820, the process determines if a thumbnail image exists at 822. If the thumbnail image exists at 822 but the item is not selected at 824, the process finishes at 826. If the thumbnail image exists at 822, the item is selected at 824, and the selected thumbnail exists at 828, the process draws the selected image at 830 and finishes at 826. If the selected thumbnail does not exist at 828, the process finishes at 826. If the thumbnail does not exist at 822, the process draws a normal image at 832. If the item is selected at 834, the process draws a selection rectangle and finishes at 826. If the item is not selected at 834, the process finishes at 826.

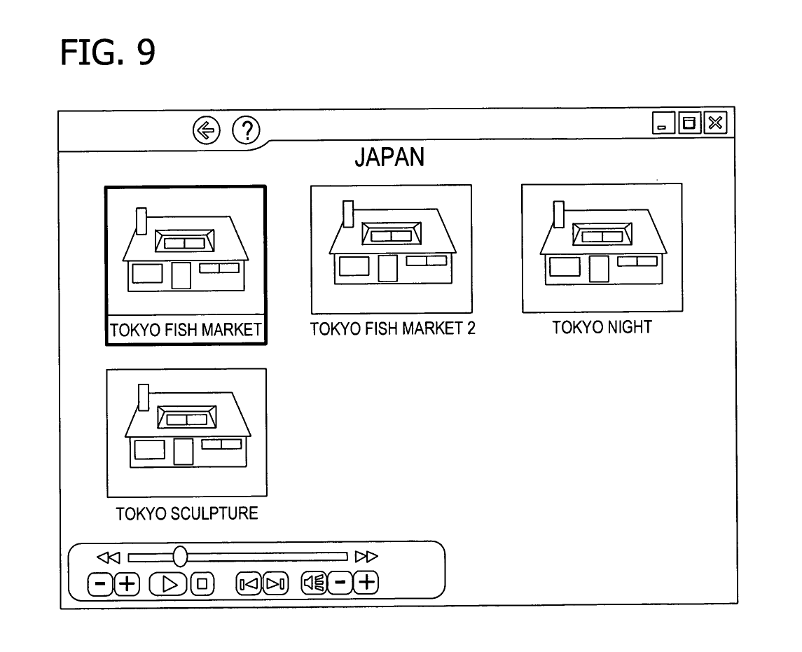

Referring next to FIG. 9, a screenshot of an exemplary menu displays thumbnail images corresponding to media content in the menu. In the example of FIG. 9, the thumbnail images are the same and represent photographs. The “Tokyo Fish Market” thumbnail image is selected and has a box around it.

Exemplary Operating Environment

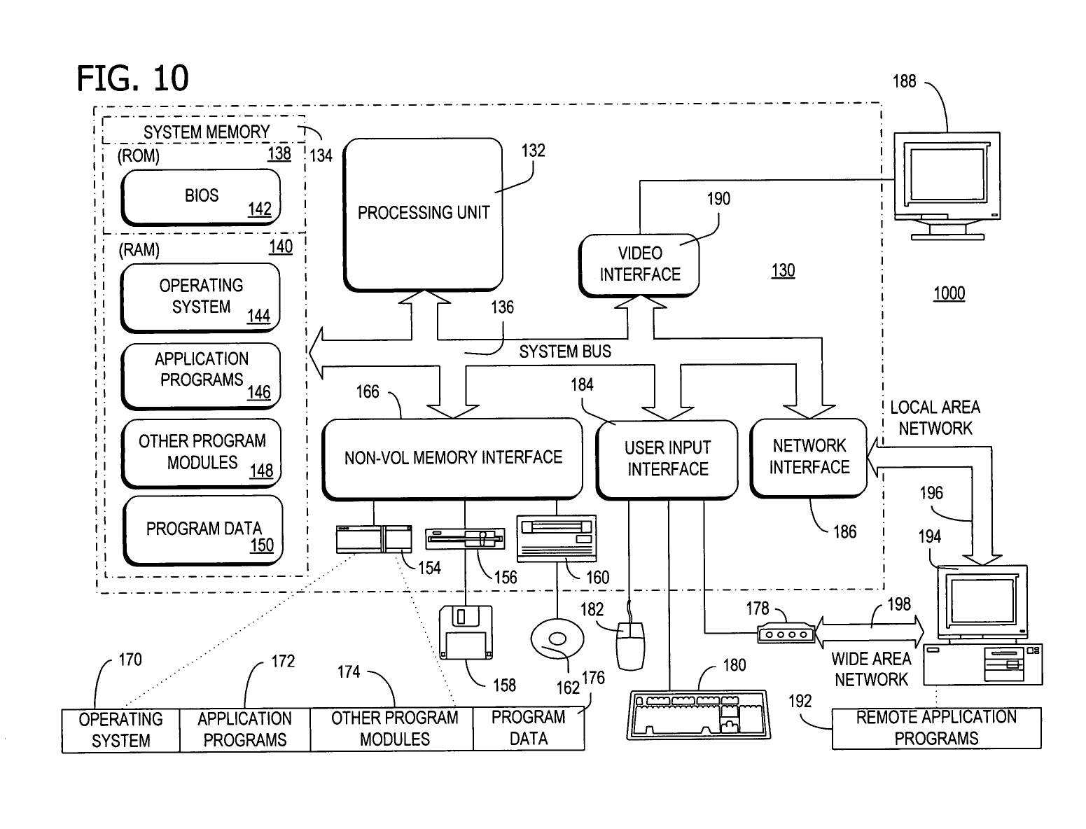

FIG. 10 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 10 illustrates operating system 144, application programs 146, other program modules 148, and program data 150.

The computer 130 may also include other removable/non-removable, volatile/nonvolatile computer storage media. For example, FIG. 10 illustrates a hard disk drive 154 that reads from or writes to non-removable, nonvolatile magnetic media. FIG. 10 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 10, provide storage of computer readable instructions, data structures, program modules and other data for the computer 130. In FIG. 10, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 10 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 10 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures to create a compound image file and render a menu to a user using a compound image file.

The following examples further illustrate the invention. The invention includes means for displaying the menu to a user for navigation and selection and means for creating the compound image file. Hardware and software such as a data structure, a user interface, an application program, an application programming interface (API), computer-executable instructions, firmware, and the like (such as illustrated in the figures) constitute means for displaying the menu to a user for navigation and selection and means for creating the compound image file. The invention is not limited to a particular method for creating the compound image files. Various methods are within the scope of the invention.

In the examples described herein, the media content of the digital media file is described in the context of content embodied on a CD or a DVD. It is to be appreciated and understood that the media content may be embodied on any suitable media and that the specific examples described herein are given to further understanding of the inventive principles. For convenience, a digital media file refers to one or more files representing, for example, a single song track or a collection of tracks such as would be found on an audio CD. The media content may include, without limitation, specially encoded media content (e.g., audio, video, or still images) in the form of an encoded media file.

The exemplary media file operations illustrated in the drawings and described herein are merely exemplary. Other variations of these file operations are within the scope of the invention. Alternatively or in addition, other media file operations not described herein yet embodying the invention are also within the scope of the invention.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A computerized method for presenting a menu of media content to a user, said computerized method comprising:
opening a menu structure file, said menu structure file defining a menu of media files;
identifying, from the opened menu structure file, a compound image file associated with the menu, said compound image file storing image data for each of the media files in the menu;
opening the identified compound image file;
retrieving the image data from the opened compound image file as a function of the menu; and
displaying the menu with the retrieved image data to a user for navigation and selection.

2. The computerized method of claim 1, wherein retrieving the image data from the opened compound image file comprises retrieving the image data from the opened compound image file in portions corresponding to a sector size of a memory area storing the compound image file.

3. The computerized method of claim 1, wherein retrieving the image data from the opened compound image file comprises retrieving thumbnail images for the media files from the opened compound image file.

4. The computerized method of claim 1, further comprising:
defining the menu structure file based on a grouping of the media files;
identifying the image data for the media files;
retrieving the identified image data from a metadata repository; and
storing the retrieved image data in the compound image file.

5. The computerized method of claim 1, wherein the compound image file stores an offset value identifying a location of the image data for each of the media files, and wherein retrieving the image data from the opened compound image file comprises retrieving the image data from the opened compound image file by seeking to the location of the image data as a function of the offset value.

6. The computerized method of claim 1, further comprising receiving a request from the user to display the menu.

7. The computerized method of claim 1, wherein one or more computer-readable media have computer-executable instructions for performing the computerized method recited in claim 1.

8. One or more computer-readable media having computer-executable components for presenting a menu of media content to a user, said components comprising:
a menu component for receiving menu data from a memory area, said menu data defining a menu of media files, wherein each of the media files has an image associated therewith;
an image component for identifying, from the menu data received by the menu component, a compound image file associated with the menu data, said compound image file storing image data for each of the media files;
a cache component for retrieving the image data from the identified compound image file as a function of the menu data; and
a display component for rendering, to a user for navigation and selection, the menu with the image data retrieved by the cache component.

9. The computer-readable media of claim 8, wherein the cache component retrieves thumbnail image data from the compound image file.

10. The computer-readable media of claim 8, further comprising an authoring component for:
defining the menu data based on a grouping of the media files;
identifying the image data for the media files;
receiving the identified image data from a metadata provider; and
storing the retrieved image data in the compound image file.

11. The computer-readable media of claim 8, wherein the menu component, image component, cache component, and display component are associated with a media player.

12. The computer-readable media of claim 8, wherein the cache component retrieves the image data from the identified compound image file in portions corresponding to a sector size of the computer-readable media.

13. A system for creating a compound image file for a menu, said system comprising:
a computer-readable medium having stored thereon a compound image file, said compound image file storing:
a plurality of images each associated with a media file, said media file being associated with at least one menu;
a plurality of image entries each storing a reference to one of the plurality of images, each of said plurality of image entries further storing a menu identifier identifying the menu associated with the image entry; and
a processor configured to execute computer-executable instructions for:
defining a menu of media files based on a grouping of the media files;
determining a menu identifier for the defined menu of media files;
identifying a plurality of images associated with the defined menu;
retrieving the identified plurality of images from a metadata repository;
storing the retrieved plurality of images in the compound image file stored on the computer-readable medium;
determining a reference to each of the stored plurality of images in the compound image file;
populating each of a plurality of image entries with the determined reference and the determined menu identifier, wherein each of the populated plurality of image entries corresponds to one of the plurality of images; and file stored on the computer-readable medium.

14. The system of claim 13, wherein the compound image file stored on the computer-readable medium further stores a menu entry for the menu, wherein the menu entry identifies one or more of the following for the menu: a background color and a text color.

15. The system of claim 13, wherein the processor is configured to store the retrieved plurality of images and the populated plurality of image entries in the compound image file on boundaries corresponding to a sector size of the computer-readable medium.

16. The system of claim 13, wherein the plurality of images stored on the computer-readable medium comprises a plurality of thumbnail images each corresponding to a media file.

17. The system of claim 13, further comprising means for displaying the menu to a user for navigation and selection.

18. The system of claim 13, further comprising means for creating the compound image file.

19. The system of claim 13, wherein the processor is configured to execute computer-executable instructions for retrieving each of the identified plurality of images from the media files associated therewith.

20. The system of claim 13, where the computer-readable medium and the processor are associated with a media player.
